(19) United States
(12) Patent Application Publication
(10) Pub. No.: US 2025/0236280 A1
(43) Pub. Date: Jul. 24, 2025

(54) HYBRID ELECTRIC VEHICLE

(71) Applicant: TOYOTA JIDOSHA KABUSHIKI KAISHA, Toyota-shi (JP)

(72) Inventor: Yuki YAMADA, Toyota-shi (JP)

(73) Assignee: TOYOTA JIDOSHA KABUSHIKI KAISHA, Toyota-shi (JP)

(21) Appl. No.: 18/916,738

(22) Filed: Oct. 16, 2024

(30) Foreign Application Priority Data
Jan. 23, 2024 (JP) 2024-007938

(51) Int. Cl. B60W 20/15; B60W 10/06; B60W 10/08

(52) U.S. Cl. CPC B60W 20/15; B60W 10/06; B60W 10/08

(57) ABSTRACT

The control device of hybrid electric vehicle acquires the plan based on the map information and the own vehicle position or the information for each travel section in the estimated traveling route, and combining the continuous travel section based on the predetermined condition, and creates a drive assistance plan on whether the vehicle travels in the motor drive mode or the normal drive mode based on the information of the combined travel sections. When the travel sections in the travel route include a predetermined motor travel section in which the hybrid electric vehicle is supposed to perform the motor driving, the control device creates the drive assistance plan without combining the predetermined motor travel section.

### CROSS-REFERENCE TO RELATED APPLICATION

This application claims priority to Japanese Patent Application No. 2024-007938 filed on Jan. 23, 2024, incorporated herein by reference in its entirety.

### BACKGROUND

### 1. Technical Field

The present disclosure relates to hybrid electric vehicles.

### 2. Description of Related Art

Conventionally, there has been proposed a hybrid electric vehicle that switches its drive mode according to a mode-switch vehicle speed (see, for example, Japanese Unexamined Patent Application Publication No. 06-187595 (JP 06-187595 A)). The drive mode includes a motor mode in which the hybrid electric vehicle runs on an electric motor alone, an engine mode in which the hybrid electric vehicle runs on an engine alone, and a combined mode that is a combination of the motor mode and the engine mode. This hybrid electric vehicle changes the mode-switch vehicle speed for each of various environments such as an urban area, a suburban area, an expressway, and a tunnel so that the hybrid electric vehicle can perform driving adapted to the environment.

### SUMMARY

In such a hybrid electric vehicle, consecutive travel sections in a travel route are sometimes combined based on a predetermined condition such as the sections being similar. The drive mode for each travel section is also set using the travel sections after the consecutive travel sections are combined. There is also a case where areas where the hybrid electric vehicle is supposed to travel in the motor mode are set in advance by the user etc. For example, these areas are the areas around the user's home and a hospital. When the travel sections in such a preset area where the hybrid electric vehicle is supposed to travel in the motor mode are also combined, the hybrid electric vehicle may not be able to appropriately travel in the motor mode.

A primary object of a hybrid electric vehicle of the present disclosure is to allow the hybrid electric vehicle to more appropriately travel in a motor mode in a preset travel section where the hybrid electric vehicle is supposed to travel in the motor mode.

In order to achieve the above primary object, the hybrid electric vehicle of the present disclosure adopts the following measures.

The hybrid electric vehicle includes: an engine configured to output traction power;
a motor configured to output traction power;
an energy storage device configured to transfer electric power to and from the motor; and
a control device configured to, when causing the hybrid electric vehicle to travel by controlling the engine and the motor by switching between a motor drive mode in which the hybrid electric vehicle performs motor driving and a normal drive mode in which the hybrid electric vehicle performs normal driving, acquire information on each of travel sections in a travel route planned or estimated based on map information and a location of the hybrid electric vehicle, combine consecutive travel sections based on a predetermined condition, create based on information on the combined travel section a drive assistance plan on whether the hybrid electric vehicle travels in the motor drive mode or the normal drive mode, and perform drive assistance control to cause the hybrid electric vehicle to travel based on the drive assistance plan, the motor driving being driving in which the hybrid electric vehicle runs on the power from the motor with the engine stopped, and the normal driving being driving in which the hybrid electric vehicle runs on the power from the engine and the power from the motor as necessary.
   The control device is configured to, when the travel sections in the travel route include a predetermined motor travel section in which the hybrid electric vehicle is supposed to perform the motor driving, create the drive assistance plan without combining the predetermined motor travel section.

The hybrid electric vehicle of the present disclosure includes: the engine configured to output traction power; the motor configured to output traction power; the energy storage device configured to transfer electric power to and from the motor; and the control device configured to control the engine and the motor by switching between the motor drive mode in which the hybrid electric vehicle performs motor driving, namely the hybrid electric vehicle runs on the power from the motor with the engine stopped, and the normal drive mode in which the hybrid electric vehicle performs normal driving, namely the hybrid electric vehicle runs on the power from the engine and the power from the motor as necessary. The control device acquires information on each of the travel sections in the travel route planned or estimated based on the map information and the location of the hybrid electric vehicle. The control device then combines consecutive travel sections based on the predetermined condition. The control device creates, based on information on the combined travel section, a drive assistance plan on whether the hybrid electric vehicle travels in the motor drive mode or the normal drive mode, and performs the drive assistance control to cause the hybrid electric vehicle to travel based on the drive assistance plan. In the case, when the travel sections in the travel route include a predetermined motor travel section in which the hybrid electric vehicle is supposed to perform the motor driving, the control device creates the drive assistance plan without combining the predetermined motor travel section. As a result, the hybrid electric vehicle can more appropriately travel in the motor drive mode in the predetermined motor travel section.

The predetermined motor travel section is, for example, a section set by a public service organization or a user. Examples of the predetermined motor travel sections include a section that belongs to an urban area, a section that belongs to an area around a hospital, and a section that belongs to an area around the user's home.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an exemplary hybrid electric vehicle 20 with a hybrid ECU 50 as a center as an embodiment of the present disclosure; and

FIG. 2 is a flow chart illustrating an exemplary section-information-obtaining and integrating process performed by the hybrid ECU 50.

### DETAILED DESCRIPTION OF EMBODIMENTS

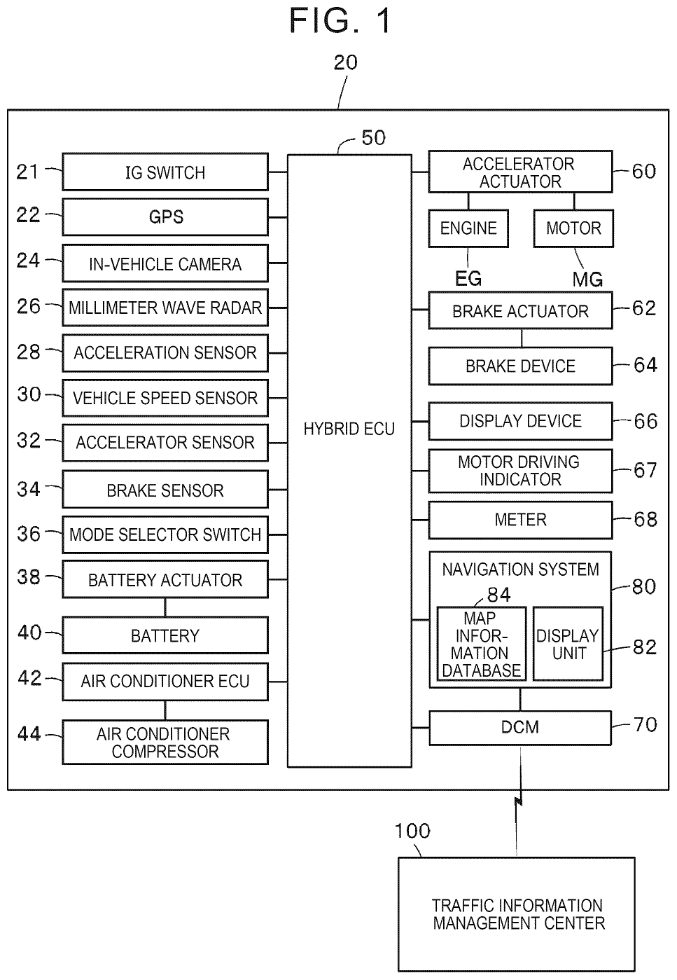

Next, a mode (embodiment) for carrying out the present disclosure will be described. FIG. 1 is a block diagram illustrating an exemplary hybrid electric vehicle 20 according to an embodiment of the present disclosure, with a hybrid electronic control unit (hereinafter, referred to as a hybrid ECU) 50 as a center. Hybrid electric vehicle 20 of the embodiment comprises an engine EG and a motor MG as a power source, as shown. In hybrid electric vehicle 20 of the embodiment, the drive mode includes a motor drive mode and a normal drive mode. The motor drive mode is a mode in which the motor is driven by power from the motor MG while the operation of the engine EG is stopped. The normal drive mode is a mode in which the engine EG is operated as needed and the traveling is performed by the power from the engine EG and the power from the motor MG.

In addition to the power source, hybrid electric vehicle 20 of the embodiment includes an ignition switch 21, a GPS (Global Positioning System, Global Positioning Satellite) 22, an in-vehicle camera 24, a millimeter wave radar 26, an acceleration sensor 28, a vehicle speed sensor 30, an accelerator sensor 32, a brake sensor 34, a mode changeover switch 36, a battery actuator 38, a battery 40, an electronic control unit for an air conditioner (hereinafter, referred to as an air conditioner ECU) 42, an air conditioner compressor 44, a hybrid ECU 50, an accelerator actuator 60, a brake actuator 62, a brake device 64, a display device 66, a motor travel indicator 67, a meter 68, a DCM (Data Communication Module) 70, a navigation system 80 and the like.

The GPS 22 is a device that detects the position of a vehicle based on signals transmitted from a plurality of GPS satellites. The in-vehicle camera 24 is a camera that images the surroundings of the vehicle, and includes, for example, a front camera that images the front of the vehicle, and a rear camera that images the rear of the vehicle. The millimeter wave radar 26 detects the inter-vehicle distance and relative speed between a host vehicle and a vehicle in front, and the inter-vehicle distance and relative speed between the host vehicle and a vehicle behind.

The acceleration sensor 28 is, for example, a sensor that detects acceleration in the longitudinal direction of the vehicle, or detects acceleration in the right-left direction (lateral direction) of the vehicle. The vehicle speed sensor 30 detects a vehicle speed based on a wheel speed and the like. The accelerator sensor 32 detects an accelerator operation amount depending on the amount of depression of an accelerator pedal by a driver. The brake sensor 34 detects a brake position as the amount of depression of a brake pedal by the driver. The mode changeover switch 36 is disposed in the vicinity of the steering wheel of the driver's seat, and is a switch for switching between the motor drive mode and the normal drive mode. Basically, when the mode changeover switch 36 is operated in the motor drive mode, the mode is switched to the normal drive mode, and when the mode changeover switch 36 is operated in the normal drive mode, the mode is switched to the motor drive mode.

The battery actuator 38 detects the state of the battery 40, such as voltage across terminals, charging/discharging current, and battery temperature, and manages the battery 40 based on these. The battery actuator 38 calculates a power storage ratio SOC, an allowable maximum output power (output limit Wout) that may be output from the battery 40, and an allowable maximum input power (input limit Win) that may be input to the battery 40. The power storage ratio SOC is a ratio of the remaining electricity storage capacity to the total electricity storage capacity calculated based on the charge/discharge current. The allowable maximum output power (output limit Wout) and the allowable maximum input power (input limit Win) are calculated based on the power storage ratio SOC, the battery temperature, and the like. The battery 40 is configured as a rechargeable and dischargeable secondary battery, and can be, for example, a lithium ion battery, a nickel metal hydride battery, a lead acid battery, or the like.

The air conditioner ECU 42 is configured as a microcomputer centered on a central processing unit (CPU) (not shown), and includes a read-only memory (ROM), a random access memory (RAM), a flash memory, an input port, an output port, a communication port, etc. in addition to the CPU. The air conditioner ECU 42 is incorporated in an air conditioner that air-conditions a passenger compartment, and drives and controls the air conditioner compressor 44 in the air conditioner so that the temperature of the passenger compartment becomes a set temperature.

The engine EG is configured, for example, as an internal combustion engine. The motor MG is configured as an electric motor that also functions as a generator, such as a synchronous generator-motor. The motor MG is connected to the battery 40 via an inverter (not shown), and can output driving force using power supplied from the battery 40 and charge the battery 40 with generated power.

The hybrid ECU 50 is configured as a microcomputer centered on a CPU (not shown), and includes, in addition to the CPU, a ROM, a RAM, a flash memory, an input port, an output port, a communication port, and the like. The hybrid ECU 50 sets a driving mode, a target operation point (target rotational speed or target torque) of the engine EG, and a torque command of the motor MG. The hybrid ECU 50 sets a target operating point (a target rotational speed or a target torque) of the engine EG and a torque command of the motor MG based on the set drive mode, an accelerator operation amount from the accelerator sensor 32, a brake position from the brake sensor 34, an output limit from the battery actuator 38, and an input limit. Note that the hybrid ECU 50 does not start in the accessory-on state, but starts in the ready-on state.

The hybrid ECU 50 sets a required driving force and a required power on the basis of an accelerator operation amount from the accelerator sensor 32 and a vehicle speed from the vehicle speed sensor 30 when the motor is traveling. Then, the hybrid ECU 50 sets the torque command of the motor MG so as to output the required driving force and the required power to the vehicles, and transmits the set torque command to the accelerator actuator 60. During the hybrid traveling, the hybrid ECU 50 sets the target operation point for the engine EG and the torque command for the motor MG so as to output the required driving force and the required power to the vehicle, and transmits the target operation point and the torque command to the accelerator actuator 60. When the brake pedal is depressed, the hybrid ECU 50 sets a required braking force based on the brake position from the brake sensor 34 and the vehicle speed from the vehicle speed sensor 30. Then, the hybrid ECU 50 sets a regenerative torque command for regenerative control of the motor MG based on the required braking force and the vehicle speed, and sets a target braking force by the braking device. The hybrid ECU 50 transmits the torque command to the accelerator actuator 60 and the target braking force to the brake actuator 62.

The accelerator actuator 60 drives and controls the engine EG and the motor MG based on the target operation point and the torque command set by the hybrid ECU 50. The accelerator actuator 60 performs intake air amount control, fuel injection control, ignition control, intake valve opening/closing timing control, etc. so that the engine EG is operated at the target operation point (target rotation speed and target torque). Further, the accelerator actuator 60 performs switching control of switching elements included in the inverter for driving the motor MG so that a torque corresponding to the torque command is output from the motor MG.

The brake actuator 62 controls the brake device 64 so that the target braking force set by the hybrid ECU 50 is applied to the vehicle by the brake device 64. The brake device 64 is configured as, for example, a hydraulically driven friction brake.

The display device 66 is built into, for example, an instrument panel in front of the driver's seat, displays various types of information, and also functions as a touch panel. The motor travel indicator 67 is incorporated in an installation panel in front of the driver's seat, although not shown, and is turned on when the motor is traveling, and is turned off when the motor is not traveling.

DCM (Data Communication Module) 70 transmits information of the host vehicle to the traffic information management center 100 and receives road traffic information from the traffic information management center 100. The information about the host vehicle includes, for example, the position of the host vehicle, vehicle speed, traveling power, and drive mode. The road traffic information includes, for example, information on current and future traffic jams, information on current average vehicle speeds and predicted future average vehicle speeds in sections on a traveling route, information on traffic regulations, information on weather, information on road surface conditions, and information on maps. The DCM 70 communicates with the traffic information management center 100 at predetermined intervals (such as, every 30 seconds, every minute, or every two minutes).

The navigation system 80 is a system for guiding the host vehicle to a set destination, and includes a display unit 82 and a map information database 84. The display unit 82 is a functional block that has a function of displaying a route to the destination, the position of the host vehicle, etc. on the display device 66 based on map information. The navigation system 80 communicates with the traffic information management center 100 via the DCM (Data Communication Module) 70. When a destination or a waypoint is set, the navigation system 80 sets a route based on the information on the destination or the waypoint and the information on the current location (the current location of the host vehicle) acquired by GPS 22 and the information stored in the map information database 84. The navigation system 80 communicates with the traffic information management center 100 at every predetermined time (such as, every three minutes, or every five minutes) to acquire the road traffic information, and provides route guidance based on the road traffic information. The map information stored in the map information database 84 includes not only data as a map but also a road gradient, a type of a road, an altitude, and the like for each travel section.

When the route guidance is performed, the navigation system 80 generates load information and the like required for traveling in the respective travel sections as pre-read information, and transmits the pre-read information to the hybrid ECU 50. The pre-read information is generated every time the road traffic information is acquired from the traffic information management center 100 (or every predetermined time). The navigation system 80 generates, as the read-ahead information, load information necessary for traveling in each travel section on the basis of information on each travel section in the travel route among the road traffic information acquired from the traffic information management center 100, information on the travel load, the vehicle speed of the host vehicle, the travel power of the host vehicle, the travel mode of the host vehicle, and the like. The read-ahead information includes: information on the own vehicle, such as the position of the own vehicle, the vehicle speed, the traveling power, and the drive mode; information on the current and future congestion; information on the predicted value of the current average vehicle speed and the future average vehicle speed in the section on the traveling route; information on the traffic regulation; information on the weather; information on the road surface condition; and information on the map. The information related to the map also includes an area (motor travel area) to which the motor is to be traveled, which is determined by a municipality or the like. The navigation system 80 can also set a motor travel area by designating an area such as an area near the home by user's operation. The navigation system 80 transmits, to the hybrid ECU 50, a signal indicating whether or not the vehicle is in the motor travel area when the vehicle is traveling.

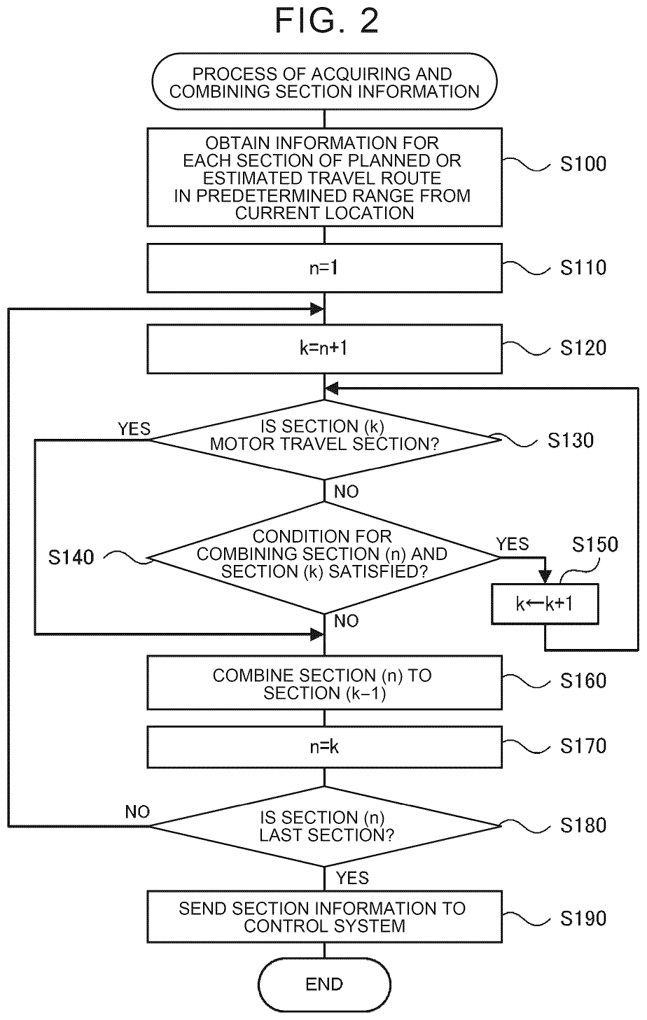

Next, an operation in hybrid electric vehicle 20 configured as described above, in particular, an operation in acquiring and integrating the information of the travel section will be described. FIG. 2 is a flowchart illustrating an example of the section information acquisition and integration processing executed by the navigation system 80. This processing is performed at predetermined time intervals or at a timing when a change occurs in the travel route.

When the section information acquiring and integrating process is executed, the navigation system 80 first acquires the information of the respective travel sections in the travel route planned or estimated from the current location in a predetermined range (S100). A 5 km, a 10 km, 15 km, or the like can be used as the predetermined area. The planned travel route is a travel route planned as route guidance from the current location to the destination by the navigation system 80 by setting the destination, and the estimated travel route is a travel route in which travel is estimated from the current location. The information to be acquired includes, in addition to the read-ahead information described above, the presence or absence of the motor traveling area, the start point and the end point of the motor traveling area when the motor traveling area is present, and the like. Note that each travel section of the travel route is defined as a travel section (1) to a travel section (i) in order from the current position.

Next, an initial value 1 is set to the first variable n (S110), and n+1 is set to the second variable k (S120). Then, it is determined whether or not the travel section (k) is a motor travel section in the motor traveling area (S130). When it is determined that the travel section (k) is not the motor travel section, it is determined whether or not the integrated condition is satisfied between the travel section (n) and the travel section (k) (S140). Examples of the integration condition include: a condition that is the same road type, a condition that the degree of congestion is the same, a condition that is not a motor travel section, a condition that the gradient is a constant range, and a condition that the distance from the start point of the travel section (n) to the end point of the travel section (k) is within a predetermined distance. When it is determined that the integrated condition is satisfied between the travel section (n) and the travel section (k), the second variable k is incremented by the value 1 (S150), and the process returns to the process of determining whether or not the travel section (k) in S130 is the motor travel section. Therefore, S130 to S150 process is repeatedly performed until the combining condition is not satisfied within a range in which the motor travel section is not included.

When it is determined that the combining condition is not satisfied between the travel section (n) and the travel section (k) in S140, the travel section (n) to the travel section (k−1) are combined (S160). When the first variable n matches k−1, the travel section to be combined is one section, and therefore the travel section (n) is the travel section after the combining. Then, the second variable k is set to the first variable n (S170), and it is determined whether or not the travel section (n) is the last travel section (S180). When it is determined that the travel section (n) is not the last travel section, the process returns to the process of setting n+1 to the second variable k of S120. Therefore, S120 to S180 process is repeated until it is determined that the travel section (n) is the last travel section.

When it is determined that the travel section (k) is the motor travel section in S130, the travel section (n) to the travel section (k−1) are combined (S160), and S170, S180 process is executed. That is, when it is determined that the travel section (k) is the motor travel section, the process returns to the process of combining up to the travel section (k−1) before the travel section (k) and setting n+1 to the second variable k of S120. When the motor running section continues, it is determined that the running section (k) is the motor running section continuously in S130, and therefore, the single motor running section is the travel section after the combining, and the motor running section is not combined. When a travel section that is not a motor travel section follows the motor travel section, it is determined that the combining condition is not satisfied in S140 because the condition that is not the motor travel section is not satisfied, and therefore, the single motor travel section is the travel section after the combining.

When it is determined in S180 that the travel section (n) is the last travel section, the information on the combined travel section in the travel route is transmitted to the hybrid ECU 50 (S190), and this process is terminated. The hybrid ECU 50 that has received the information of each travel section of the travel route after the combining creates a drive assistance plan that assigns the motor drive mode or the normal drive mode to each travel section of the travel route. Then, the hybrid ECU 50 executes the drive assistance control to cause the hybrid electric vehicle to travel in the motor drive mode or the normal drive mode according to the drive assistance plan.

In hybrid electric vehicle 20 of the embodiment described above, the navigation system 80 combines the travel sections without combining the motor travel sections set as the motor travel areas, when combining the travel sections after acquiring the information of the respective travel sections in the planned or estimated travel route in a predetermined range from the current location. Then, the navigation system 80 transmits the information of the respective travel sections in the travel route after the sections are combined to the hybrid ECU 50 that creates the drive assistance plan. As a result, the drive assistance plan is always created as a single travel section for the predetermined motor travel section. Therefore, by combining the motor travel section and the other travel sections, it is possible to reduce the possibility that the battery electric vehicle may travel in the normal drive mode in the motor travel section. As a result, the motor travel section can be more appropriately traveled in the motor drive mode.

In hybrid electric vehicle 20 of the embodiment, it is assumed that the navigation system 80 executes a section information acquiring and combining process of combining the respective travel sections in the travel route planned or estimated from the current location. However, the process of acquiring and combining section information may be executed by the hybrid ECU 50.

The correspondence between the main elements of the embodiments and the main elements of the disclosure described in the column of the means for solving the problem will be described. In the embodiment, the engine EG corresponds to the “engine”, the motor MG corresponds to the “motor”, the battery 40 corresponds to the “energy storage device”, and the hybrid-use electronic control unit 50 and the navigation system 80 correspond to the “control device”.

The correspondence between the main elements of the embodiment and the main elements of the disclosure described in the section of the means for solving the problem is an example for specifically explaining the embodiment of the disclosure described in the section of the means for solving the problem. The main elements of the embodiments are not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of a hybrid electric vehicle and the like.

What is claimed is:

1. A hybrid electric vehicle, comprising:
an engine configured to output traction power;
a motor configured to output traction power;
an energy storage device configured to transfer electric power to and from the motor; and
a control device configured to, when causing the hybrid electric vehicle to travel by controlling the engine and the motor by switching between a motor drive mode in which the hybrid electric vehicle performs motor driving and a normal drive mode in which the hybrid electric vehicle performs normal driving, acquire information on each of travel sections in a travel route planned or estimated based on map information and a location of the hybrid electric vehicle, combine consecutive travel sections based on a predetermined condition, create based on information on the combined travel section a drive assistance plan on whether the hybrid electric vehicle travels in the motor drive mode or the normal drive mode, and perform drive assistance control to cause the hybrid electric vehicle to travel based on the drive assistance plan, the motor driving being driving in which the hybrid electric vehicle runs on the power from the motor with the engine stopped, and the normal driving being driving in which the hybrid electric vehicle runs on the power from the engine and the power from the motor as necessary, wherein the control device is configured to, when the travel sections in the travel route include a predetermined motor travel section in which the hybrid electric vehicle is supposed to perform the motor driving, create the drive assistance plan without combining the predetermined motor travel section.

2. The hybrid electric vehicle according to claim 1, wherein the predetermined motor travel section is a section set by a user.
